(19) United States
(12) Patent Application Publication
(10) Pub. No.: US 2013/0106843 A1
(43) Pub. Date: May 2, 2013

(54) INFORMATION PROCESSING APPARATUS, DISPLAY CONTROL METHOD, AND PROGRAM

(71) Applicant: Sony Corporatioon, Tokyo (JP)

(72) Inventor: Takuro Noda, Tokyo (JP)

(73) Assignee: SONY CORPORATION, Tokyo (JP)

(21) Appl. No.: 13/661,631

(22) Filed: Oct. 26, 2012

(30) Foreign Application Priority Data
Nov. 2, 2011 (JP) 2011-241234

(51) Int. Cl. G06T 15/00

(52) U.S. Cl. 345/419

(57) ABSTRACT

There is provided an information processing apparatus including an inclination detection unit that detects an inclination of a user's face in a horizontal direction of a display screen, and a control unit that controls parallax in the horizontal direction between right-eye and left-eye images displayed on the display screen in accordance with a detection result of the inclination detection unit.

### BACKGROUND

The present disclosure relates to an information processing apparatus, a display control method, and a program.

In recent years, a three-dimensional stereoscopic video that a viewer can stereoscopically view has been popularized. As a system of viewing a three-dimensional stereoscopic video, a binocular parallax system enabling a viewer to stereoscopically view a video by displaying right-eye and left-eye videos having parallax in a horizontal direction has been proliferating.

For a viewer to view such a three-dimensional stereoscopic video more naturally, a technology for correcting an error of a three-dimensional stereoscopic video signal dependent on positional accuracy or the like of two cameras (right-eye and left-eye cameras) when photographing a three-dimensional stereoscopic video is disclosed in Japanese Unexamined Patent Application Publication No. 2011-77984.

### SUMMARY

However, the correction of the three-dimensional stereoscopic video signal disclosed in Japanese Unexamined Patent Application Publication No. 2011-77984 is not controlled in accordance with the position of a viewer viewing a three-dimensional stereoscopic video.

In the recent stereoscopic video technologies, a system enabling a viewer to view a three-dimensional stereoscopic video with the naked eye and a system enabling a view to use dedicated glasses are known. However, there is a problem that the stereoscopic video is not correctly viewed and thus a burden is placed on the eyes of the viewer (user) when the viewer inclines his or her face.

It is desirable to provide a novel and improved information processing apparatus, display control method, and program capable of reducing a burden on the eyes of a user by controlling parallax between right-eye and left-eye images in accordance with an inclination of a user's face.

According to an embodiment of the present disclosure, there is provided an information processing apparatus including an inclination detection unit that detects an inclination of a user's face in a horizontal direction of a display screen, and a control unit that controls parallax in the horizontal direction between right-eye and left-eye images displayed on the display screen in accordance with a detection result of the inclination detection unit.

According to another embodiment of the present disclosure, there is provided a display control method including detecting an inclination of a user's face in a horizontal direction of a display screen, and controlling parallax in the horizontal direction between right-eye and left-eye images displayed on the display screen in accordance with a detection result obtained by the step of detecting an inclination.

According to still another embodiment of the present disclosure, there is provided a program causing a computer to execute a process of detecting an inclination of a user's face in a horizontal direction of a display screen, and a process of controlling parallax in the horizontal direction between right-eye and left-eye images displayed on the display screen in accordance with a detection result obtained by the process of detecting the inclination.

According to the embodiments of the present disclosure described above, it is possible to reduce the burden on the eyes of a user by controlling parallax between right-eye and left-eye images in accordance with an inclination of the user's face.

### BRIEF DESCRIPTION OF THE DRAWINGS

FIG. 1 is a diagram illustrating an overview of control of a three-dimensional stereoscopic video according to an embodiment of the present disclosure;

FIG. 2 is a block diagram illustrating an example of a hardware configuration of an information processing apparatus according to a first embodiment of the present disclosure;

FIG. 3 is a block diagram illustrating a functional configuration of a CPU (control unit) according to the first embodiment of the present disclosure;

FIG. 4 is a diagram illustrating a captured image obtained from an image sensor according to the first embodiment;

FIG. 5 is a diagram illustrating control of the positions of virtual cameras according to the first embodiment;

FIG. 6 is a diagram illustrating examples of right-eye and left-eye images having parallax controlled in the xy directions;

FIG. 7 is a flowchart illustrating operation processing according to the first embodiment;

FIG. 8 is a diagram illustrating images when videos are allocated in the horizontal and vertical directions;

FIG. 9 is a diagram illustrating a system of using circularly-polarizing glasses;

FIG. 10 is a diagram illustrating an inclination 0 of each user's face detected when a plurality of users view a three-dimensional stereoscopic video;

FIG. 11 is a block diagram illustrating a functional configuration of a CPU according to a second embodiment of the present disclosure;

FIG. 12 is a diagram illustrating an overview according to a third embodiment of the present disclosure;

FIG. 13 is a block diagram illustrating an example of the configuration of an information processing apparatus according to the third embodiment of the present disclosure;

FIG. 14 is a diagram illustrating an inclination 0 with respect to a gravity direction G of the information processing apparatus according to the third embodiment of the present disclosure;

FIG. 15 is a block diagram illustrating a functional configuration of a CPU according to the third embodiment of the present disclosure; and

FIG. 16 is a diagram illustrating control of the positions of virtual cameras according to the third embodiment.

### DETAILED DESCRIPTION OF THE EMBODIMENTS

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

The description will be made in the following order

1. Overview of Control of Parallax Between Three-Dimensional Stereoscopic Videos

2. Embodiments
2-1. First Embodiment
2-2. Second Embodiment
2-3. Third Embodiment

3. Summarization

1. Overview of Control of Parallax Between Three-Dimensional Stereoscopic Videos

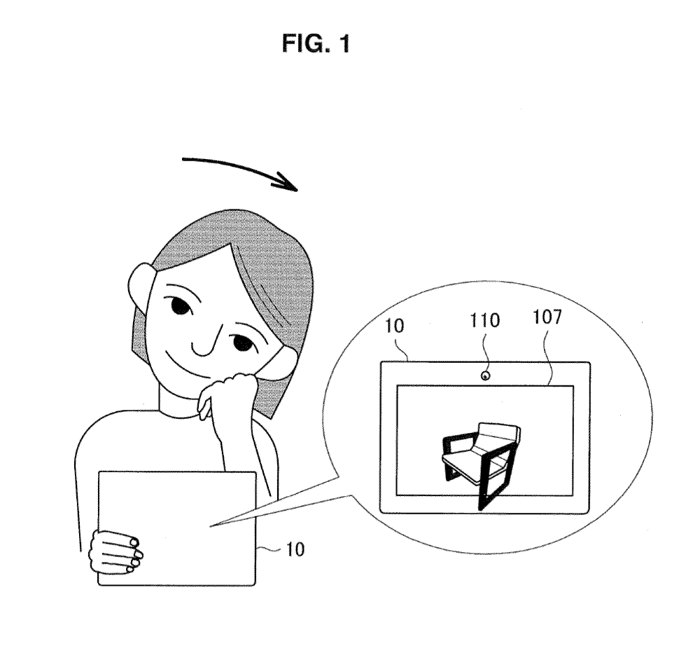

First, an overview of control of parallax between three-dimensional stereoscopic videos according to an embodiment of the present disclosure will be described with reference to FIG. 1. As shown in FIG. 1, an information processing apparatus 10 according to the embodiment of the present disclosure is a tablet-type apparatus that includes a display device 107. The information processing apparatus 10 further includes an image sensor 110 that images a user which is a viewer.

Here, a double-eye parallax system of enabling a viewer to stereoscopically view a video by displaying right-eye and left-eye videos having parallax is used as an example of a system of viewing a three-dimensional stereoscopic video according to this embodiment. As described above, the double-eye parallax system is classified into a glasses-type system using dedicated glasses and a naked-eye-type system using no glasses.

The glasses-type system is classified into a polarized-light system of separating an image into right-eye and left-eye images using a difference in polarized light and a shutter system of providing glasses having shutters that perform opening and closing right and left alternately and synchronizing the opening and closing of the shutters of the glasses with right-eye and left-eye images displayed in a time division manner.

The naked-eye-type system is classified into a lenticular system and a parallax barrier system. In the lenticular system, convex fine lenses (lenticular lenses) are arranged to separate a light path into light paths of right-eye and left-eye images. In the parallax barrier system, parallax barriers blocking light and vertical slits which are regions transmitting light are alternately arranged to separate a light path into light paths of right-eye and left eye images.

In the double-eye parallax system described above, a normal three-dimensional stereoscopic video is formed by appropriately displaying right-eye and left-eye images for right and left eyes, respectively. However, there is a problem that a view position or a view range is limited.

For example, right-eye and left-eye images typically have parallax in a horizontal direction on the assumption that a user views the images within a predetermined view range. However, when the user inclines his or her face, the user views the images out of the predetermined view range, and thus normal three-dimensional stereoscopic videos are not formed. In particular, a reverse viewing state occurs since the right-eye image is viewed by the left eye and the left-eye image is viewed by the right eye. In this case, a burden is placed on the eyes of the user.

In the parallax barrier system in which the vertical slits and the parallax barriers are used, when the user inclines his or her face nearly 90 degrees while viewing, as in FIG. 1, two eyes of the user are located vertically with respect to a display screen and the same video may be viewed by the eyes of the user. Therefore, normal three-dimensional stereoscopic videos may not be formed.

Thus, when the user inclines his or her face, normal three-dimensional stereoscopic videos are not viewed, and thus a burden is placed on the eyes of the user.

Accordingly, in control of the parallax between three-dimensional stereoscopic videos according to the embodiment of the present disclosure, the burden on the eyes of the user can be reduced by controlling parallax between the right-eye and left-eye images in accordance with an inclination of the face of a user viewing the three-dimensional stereoscopic videos.

The overview of the parallax control of a three-dimensional stereoscopic video according to the embodiment of the present disclosure has been described. Next, the control of parallax between three-dimensional stereoscopic videos will be described according to a plurality of embodiments of the present disclosure.

2. Embodiments

Hereinafter, an information processing apparatus performing the control of parallax between three-dimensional stereoscopic videos will be described according to first to third embodiments of the present disclosure.

2-1. First Embodiment

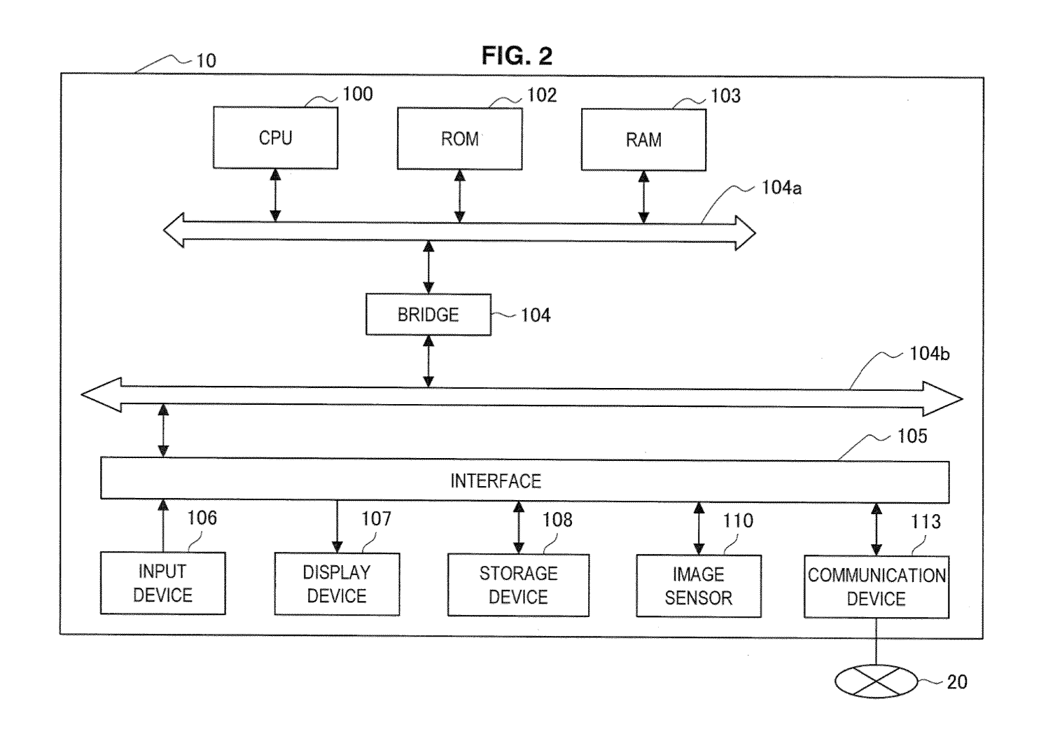

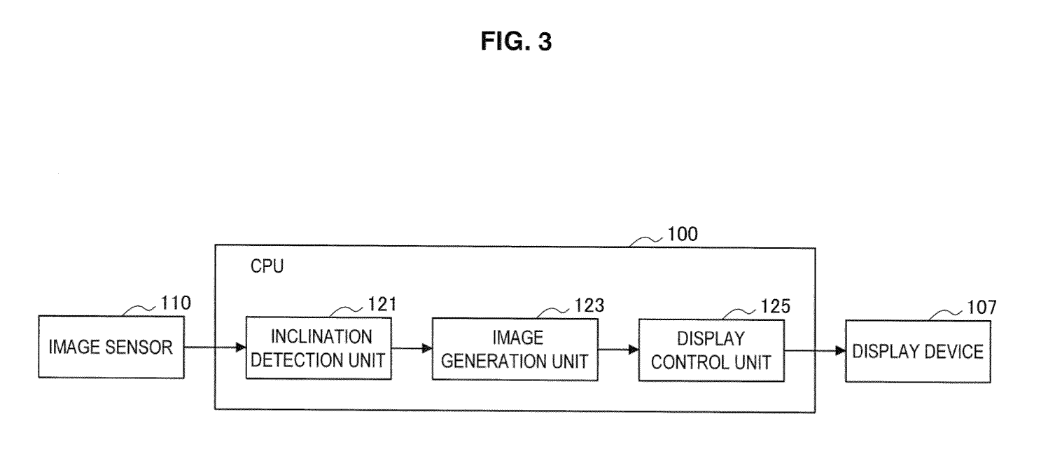

The information processing apparatus 10 according to the first embodiment detects an inclination of a user's face using the image sensor 110 of the information processing apparatus 10 and performs control of parallax between three-dimensional stereoscopic videos in accordance with the detected inclination of the user's face. Hereinafter, the configuration of the information processing apparatus 10 according to the first embodiment will be described with reference to FIGS. 2 and 3.

Hardware Configuration of Information Processing Apparatus 10

FIG. 2 is a block diagram illustrating an example of a hardware configuration of the information processing apparatus 10 according to this embodiment. As shown in FIG. 2, the information processing apparatus 10 according to this embodiment includes a central processing unit (CPU) 100, a read-only memory (ROM) 102, a random access memory (RAM) 103, a host bus 104a, a bridge 104, an external bus 104b, an interface 105, an input device 106, a display device 107, a storage device 108, an image sensor 110, and a communication device 113.

The CPU 100 functions as a calculation processing unit and a control unit, and controls all of the processes of the information processing apparatus 10 in accordance with various programs. Further, the CPU 100 may be a microprocessor. Specific functions of the CPU 100 (control unit) according to this embodiment will be described in detail later.

The ROM 102 stores programs, calculation parameters, and the like to be used by the CPU 100. The RAM 103 temporarily stores programs executed by the CPU 100 and parameters or the like appropriately changed in the execution of the programs. The CPU 100, the ROM 102, and the RAM 103 are connected to each other by the host bus 104a configured by a CPU bus or the like.

The host bus 104a is connected to the external bus 104b such as a peripheral component interconnect/interface (PCI) bus via the bridge 104. The host bus 104a, the bridge 104, and the external bus 104b may not necessarily be configured in a separated manner, but the functions of the host bus 104a, the bridge 104, and the external bus 104b may be realized by a single bus.

The input device 106 includes an input unit, such as a touch panel, a button, a microphone, or a switch, that is used for a user to input information and an input control circuit that generates an input signal in response to an input of the user and outputs the generated input signal to the CPU 100. The user of the information processing apparatus 10 can operate the input device 106 to input various kinds of data to the information processing apparatus 10 or instruct a processing operation.

The display device 107 is a display unit such as a cathode ray tube (CRT) display device, a liquid crystal display (LCD) device, or an organic light emitting diode (OLED) device.

The storage device 108 is a device that is configured as an example of a storage unit of the information processing device 10 and stores data. The storage device 108 may include a storage medium, a recording device that records data on a storage medium, a reading device that reads the data from the storage medium, and a deleting device that deletes the data recorded on the storage medium. Further, the storage device 108 stores programs to be executed by the CPU 100 or various kinds of data.

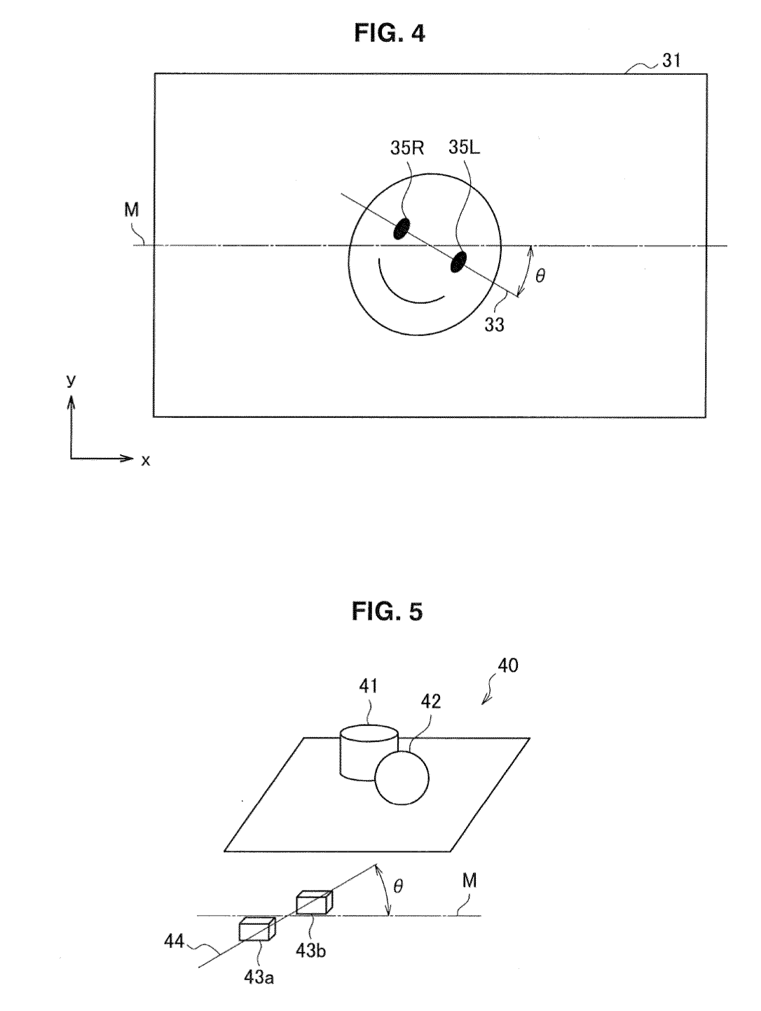

The image sensor 110 is an imaging unit that images a subject. The image sensor 110 outputs a captured image to the RAM 103. The image sensor 110 according to this embodiment is used to detect an inclination of a user's face. The detection of an inclination of a user's face performed by the image sensor 110 will be described in detail later with reference to FIG. 4.

For example, the communication device 113 is a communication interface configured by a communication device connected to a communication network 20. Further, the communication device 113 may be a communication device corresponding to a wireless local area network (LAN).

The example of the hardware configuration of the information processing apparatus 10 according to this embodiment has been described in detail. Next, a functional configuration of the CPU 100 (control unit) according to this embodiment will be described in detail with reference to FIG. 3.

Functional Configuration of CPU 100

FIG. 3 is a block diagram illustrating the functional configuration of the CPU 100 (control unit) according to this embodiment. As shown in FIG. 3, the CPU 100 functions as an inclination detection unit 121, an image generation unit 123, and a display control unit 125. Thus, the CPU 100 according to this embodiment can detect an inclination of a user's face based on an image (captured image) output from the image sensor 110 and can display right-eye and left-eye images having parallax controlled in accordance with the detection result on the display device 107. Hereinafter, each functional configuration shown in FIG. 3 will be described.

Inclination Detection Unit 121

The inclination detection unit 121 can recognize the position of the user's face on the captured image output from the image sensor 110 or part information regarding the position of the user's face and can detect the inclination of the user's face. The inclination detection unit 121 outputs the detection result to the image generation unit 123.

Here, the detection of the inclination of the user's face performed by the inclination detection unit 121 may be performed based on, for example, the positions of eyes or the position of a nose. An example of the detection of the inclination performed by the inclination detection unit 121 will be described in detail with reference to FIG. 4.

FIG. 4 is a diagram illustrating a captured image 31 output from the image sensor 110. As shown in FIG. 4, the inclination detection unit 121 analyzes the captured image 31 and recognizes the position of the user's face and a part of the face. Here, for example, the inclination detection unit 121 recognizes eyes (a right eye 35R and a left eye 35L) of the user, as shown in FIG. 4. Then, the inclination detection unit 121 detects, as an inclination of the user's face, an angle θ formed between a line 33 connecting the recognized right eye 35R to the recognized left eye 35L and a horizontal line M formed in a horizontal direction of the display device 107. As the user gradually inclines his or her face, a difference between the positions of the right eye 35R and the left eye 35L of the user decreases in the x direction (horizontal direction) and increases in the y direction (vertical direction), as in FIG. 4.

Image Generation Unit 123

The image generation unit 123 generates right-eye and left-eye images having parallax controlled in accordance with the inclination of the user's face based on the detection result output from the inclination detection unit 121. The image generation unit 123 outputs the generated right-eye and left-eye images to the display control unit 125.

For example, the image generation unit 123 can generate the right-eye and left-eye images having parallax in the xy directions by adjusting the positions of virtual cameras that observe a three-dimensional virtual space modeled in advance in accordance with an inclination of the user's face. Hereinafter, a virtual space used to generate the images will be described with reference to FIG. 5.

FIG. 5 is a diagram illustrating a virtual space 40. In the virtual space 40, as shown in FIG. 5, 3D stereoscopic models (objects) 41 and 42 can be modeled and subjected to rendering from any position by virtual cameras 43a and 43b that observe the virtual space 40.

The positions of the virtual cameras 43a and 43b are adjusted in accordance with an angle θ of the user's face output from the inclination detection unit 121. In the example shown in FIG. 5, the virtual camera 43a corresponds to the left eye 35L of the user and the virtual camera 43b corresponds to the right eye 35R. Therefore, the positions of the virtual cameras 43a and 43b are adjusted so that an angle θ is formed with respect to a line 44 connecting the virtual camera 43a to the virtual camera 43b.

After adjusting the positions of the virtual cameras 43 in this manner, the image generation unit 123 can perform rendering to generate the right-eye and left-eye images having the parallax controlled in the xy directions in accordance with an inclination of the user's face.

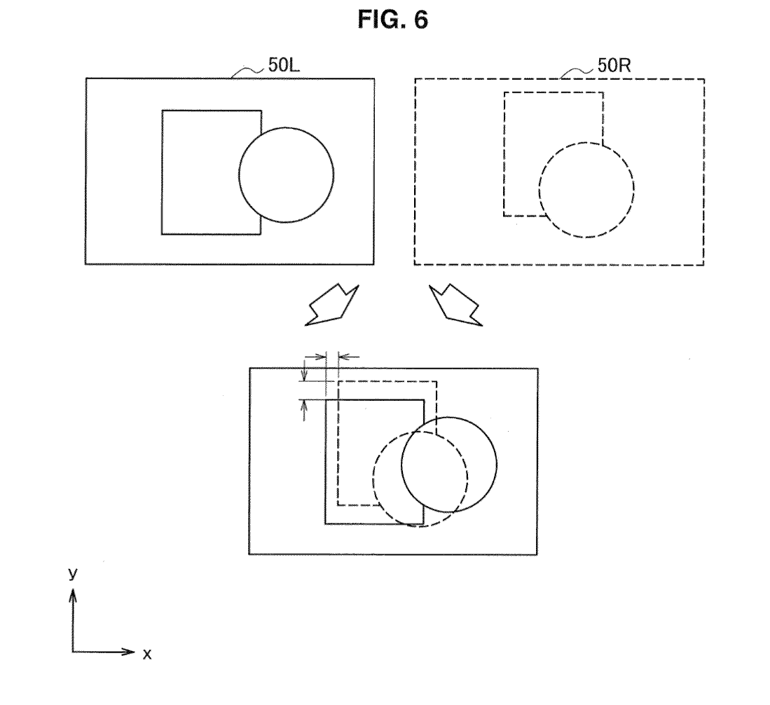

Examples of the generated right-eye and left-eye images are shown in FIG. 6. A left-eye image 50L shown in FIG. 6 is an image acquired from the virtual camera 43a and a right-eye image 50R is an image acquired from the virtual camera 43b. As shown on the lower side of FIG. 6, the left-eye image 50L and the right-eye image 50R have parallax in the xy directions in accordance with an inclination of the user's face.

Display Control Unit 125

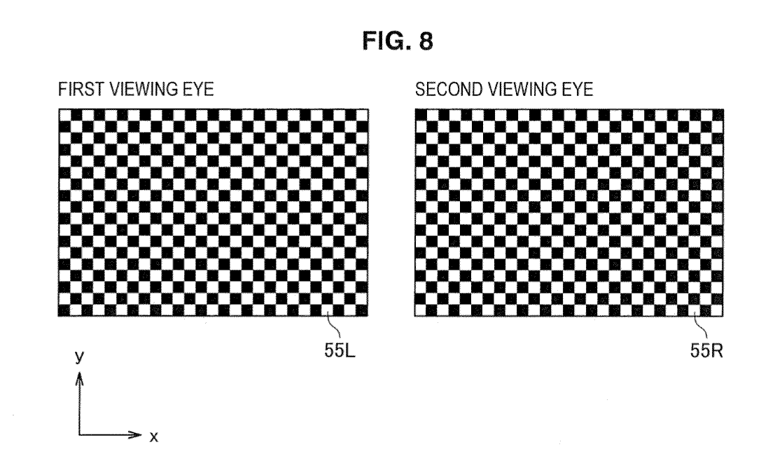

The display control unit 125 controls the right-eye and left-eye images output from the image generation unit 123 such that the right-eye and left-eye images are displayed on the display device 107. The display control unit 125 performs display control such that correct images are allocated to the two eyes of the user in accordance with a specific system (the naked-eye-type system or the glasses-type system described above) of realizing a three-dimensional stereoscopic video. The allocation of binocular parallax images will be described later with reference to FIG. 8.

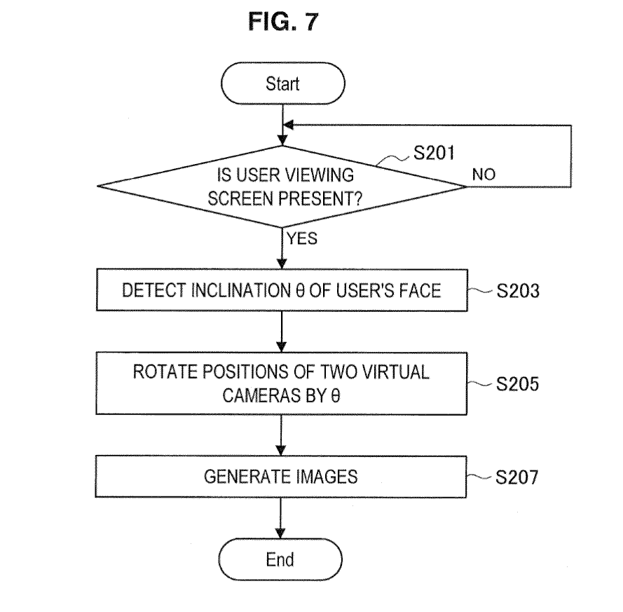

The functional configuration of the CPU 100 according to this embodiment has been described in detail. Next, operation processing of the CPU 100 according to this embodiment will be described with reference to FIG. 7.

Operation processing by CPU 100

FIG. 7 is a flowchart illustrating the operation processing of the CPU 100 according to this embodiment. As shown in FIG. 7, in step S201, the CPU 100 first determines whether a user viewing the display device 107 (display screen) is present. As a specific determination method, the CPU 100 may determine that the user viewing the display screen is present, for example, when the CPU 100 analyzes an image captured by the image sensor 110 and recognizes the user's face.

In step S203, the inclination detection unit 121 detects an inclination θ of the user's face by analyzing the image captured by the image sensor 110. Then, the inclination detection unit 121 outputs the detection result indicating the inclination θ to the image generation unit 123.

In step S205, the image generation unit 123 rotates the positions of the two virtual cameras 43a and 43b observing the virtual space 40 by the inclination θ of the user's face detected by the inclination detection unit 12.

In step S207, the image generation unit 123 can generate the right-eye and left-eye images having the parallax in the xy directions in accordance with the inclination of the user's face by acquiring images from the rotated virtual cameras 43a and 43b.

The operation processing of the CPU 100 has been described. Next, a specific example in which right-eye and left-eye images generated by causing the CPU 100 to control the parallax in the xy directions (horizontal and/or vertical directions) are correctly allocated to two eyes of a viewer will be described.

Allocation of Binocular Parallax Image

For example, in the case of the naked-eye-type system, videos may be allocated in not only the horizontal direction but also the vertical direction so that appropriate images correctly arrive at the right and left eyes even when the user inclines his or her face. FIG. 8 is a diagram illustrating images viewed by a first viewing eye (right eye) and a second viewing eye (left eye) when the videos are allocated in not only the horizontal direction but also the vertical direction.

As shown in FIG. 8, the pixels (or sub-pixels) of an image are allocated to the horizontal and vertical directions. Thus, the pixels of white portions 55L of the image shown on the left side of FIG. 8 are viewed by the first viewing eye (left eye) and the pixels of the white portions 55R shown on the right side of FIG. 8 are viewed by the second viewing eye (right eye).

By allocating three-dimensional stereoscopic videos having the parallax in the xy directions in the horizontal and vertical directions, correct information is input to two eyes, and thus the user can correctly view the three-dimensional stereoscopic videos, even when the user inclines his or her face 90 degrees. In this case, the CPU 100 displays an image in which the white portions of the images shown on the right and left sides of FIG. 8 are combined on the display device 107.

As shown in FIG. 8, an optical element used to allocate images may be, for example, a parallax barrier in which parallax barriers blocking light and slits which are regions transmitting the light are arranged in a lattice shape (that is, the parallax barriers are arranged obliquely). Further, an optical element in which lenticular lenses are arranged in a grid-like pattern may be used.

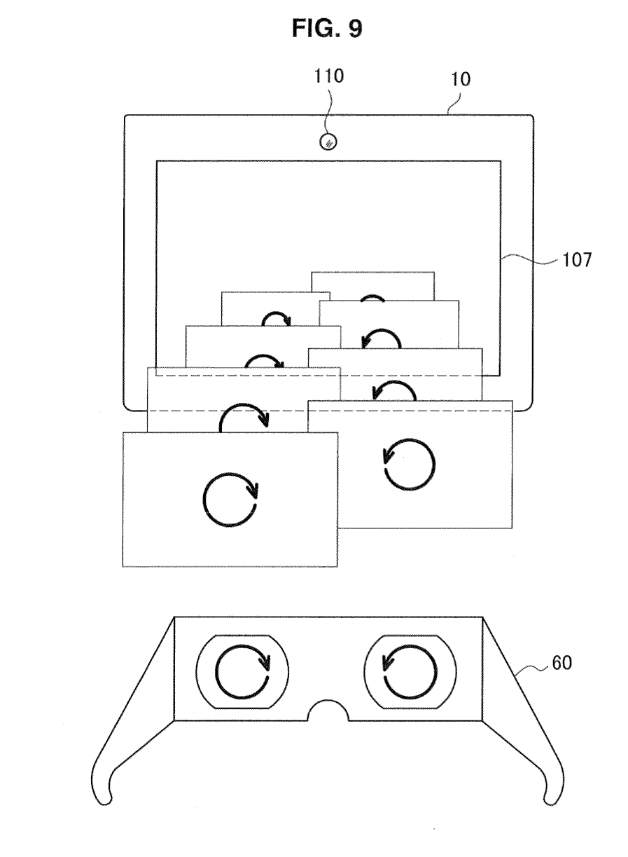

The specific method of allocating the images when the naked-eye-type system is realized has been described. On the other hand, when the glasses-type system is realized, for example, as in FIG. 9, videos viewed by the right and left eyes may be allocated using circularly-polarizing glasses 60.

In a circularly-polarizing glasses system, the CPU 100 alternately displays right-eye and left-eye images on the display device 107 and provides circularly-polarized light in different rotation directions by a filter (not shown). Since the circularly-polarizing glasses 60 performing polarization in the same direction as the direction of the polarized light of each of the right-eye and left-eye images are used, correct information is input to the two eyes. In this case, even when the user inclines his or her face 90 degrees, the correct information is input to the two eyes. Therefore, the user can correctly view the stereoscopic videos.

When the glasses-type system is realized, videos viewed by the right and left eyes may be allocated using shutter glasses that perform opening and closing alternately.

In a shutter glasses system, correct information is input to the two eyes of the user by synchronizing the timing at which right-eye and left-eye images are alternately displayed on the display device 107 with the timing at which the shutter glasses perform opening and closing. In this case, the correct information is input to the two eyes of the user, even when the user inclines his or her face 90 degrees. Therefore, the user can correctly view the stereoscopic videos.

According to the first embodiment of the present disclosure, as described above, it is possible to generate the right-eye and left-eye images having the parallax formed dynamically in the two-dimensional xy directions in accordance with an inclination (a change in the positions of the eyes of the user in the xy directions) of the user's face. Thus, by correctly allocating the generated videos to the eyes of the inclined user's face, the user can correctly view the three-dimensional stereoscopic videos even when the user inclines his or her face. Accordingly, the burden on the eyes of the user is reduced.

In the above-described first embodiment, the case in which the three-dimensional stereoscopic videos having two types of parallax are generated has been described, but the embodiment of the present disclosure is not limited thereto. For example, even when three-dimensional stereoscopic videos having four or more types of parallax are generated, the parallax can be controlled likewise in the xy directions in accordance with the inclination of the user's face.

In the above-described first embodiment, the three-dimensional stereoscopic videos having the parallax controlled in the horizontal and vertical directions in the virtual space 40 modeled in advance have been generated, but the embodiment of the present disclosure is not limited thereto.

For example, in a case of video contents having parallax in the horizontal direction, videos having multiple types of parallax are superimposed in a virtual plane. Therefore, by adding a change in the parallax to the plane, the parallax can be controlled likewise in accordance with the inclination of the user's face. In this case, however, since the parallax in the vertical direction is not originally included, only the parallax in the horizontal direction is controlled. However, the burden on the eyes of the user can be reduced. For example, as the user inclines his or her face, the parallax in the horizontal direction is eliminated. When the user inclines his or her face by 90 degrees, the user can view a two-dimensional video, and thus the burden on the eyes of the user can be reduced.

By structuring the virtual space again from the video contents having parallax in the horizontal direction, pseudo-parallax in the vertical direction can be created. Thus, the parallax in the horizontal and vertical directions can be controlled in accordance with the inclination of the user's face. For example, even when the user inclines his or her face 90 degrees, the user can correctly view the three-dimensional stereoscopic videos.

2-2. Second Embodiment

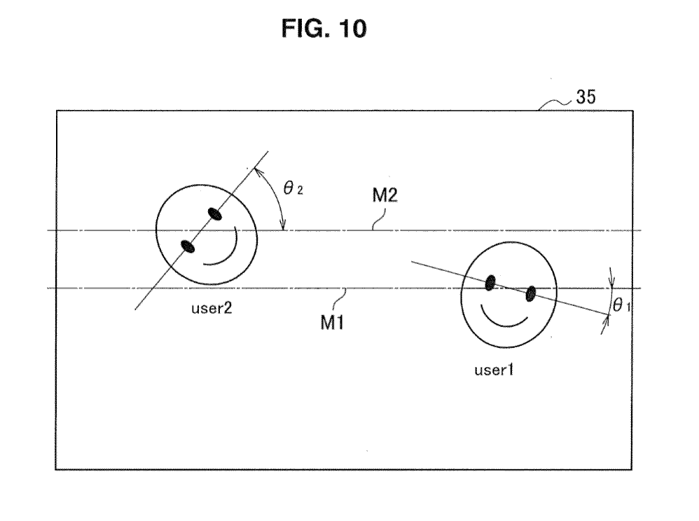

In the above-described first embodiment, the parallax has been controlled according to an inclination of the face of one user who views the three-dimensional stereoscopic videos. On the other hand, when a plurality of users simultaneously view three-dimensional stereoscopic videos, there is a high probability of different inclinations θ being detected for the users, as in FIG. 10.

FIG. 10 is a diagram illustrating the inclinations θ detected when a plurality of users view three-dimensional stereoscopic videos. In FIG. 10, in an image 33 captured by the image sensor 110, an angle θ formed by a line connecting each user's eyes and a horizontal line M corresponding to the horizontal direction of the display device 107 is different for each user.

When the plurality of users simultaneously view the three-dimensional stereoscopic videos, different inclinations θ such as an inclination θ01 of the face of User 1 and an inclination θ02 of the face of User 2 are detected, as in FIG. 10. Therefore, it is difficult to control the parallax in the horizontal and vertical directions, as in the first embodiment.

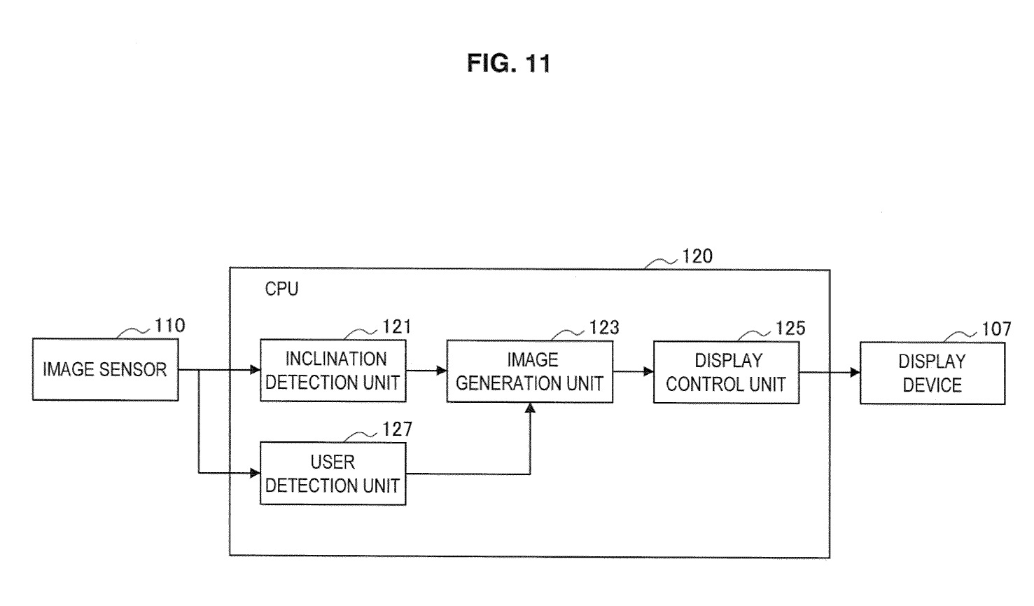

In the second embodiment of the present disclosure, when a plurality of users viewing the three-dimensional stereoscopic videos are detected, parallax is created only in the horizontal direction so that the users can view the three-dimensional stereoscopic videos. Therefore, the burden on the eyes of the users can be reduced. A functional configuration of a CPU according to the second embodiment will be described below with reference to FIG. 11.

Functional Configuration of CPU 120 According to Second Embodiment

FIG. 11 is a diagram illustrating the functional configuration of the CPU 120 according to the second embodiment. As shown in FIG. 11, the CPU 120 includes an inclination detection unit 121, an image generation unit 123, a display control unit 125, and a user detection unit 127.

The user detection unit 127 according to this embodiment detects whether a plurality of users viewing the three-dimensional stereoscopic videos are present based on an image captured by the image sensor 110, and then outputs the detection result to the image generation unit 123. Then, the image generation unit 123 generates three-dimensional stereoscopic videos having parallax controlled in the horizontal direction and/or parallax controlled in the vertical direction based on the detection result obtained by the user detection unit 127, and then outputs the generated three-dimensional stereoscopic videos to the display control unit 125.

More specifically, when one user viewing the three-dimensional stereoscopic videos is detected, the image generation unit 123 generates the three-dimensional stereoscopic videos having parallax controlled in the horizontal direction and/or parallax controlled in the vertical direction in accordance with an inclination of the user's face detected by the inclination detection unit 121, as in the first embodiment. On the other hand, when a plurality of users viewing the three-dimensional stereoscopic videos are present, the image generation unit 123 generates the three-dimensional stereoscopic videos having parallax controlled only in the horizontal direction, and then outputs the generated three-dimensional stereoscopic videos to the display control unit 125.

Thus, when the plurality of users viewing the three-dimensional stereoscopic videos are present, the CPU 120 controls parallax only in the horizontal direction. However, the burden on the eyes of the users can be reduced. For example, as the users gradually incline their faces, a difference between the eyes of each user in the x direction decreases. Therefore, the parallax in the horizontal direction between the three-dimensional stereoscopic videos is lost. Further, when the face of each user is inclined nearly 90 degrees, the parallax in the horizontal direction becomes almost zero, and thus a two-dimensional video is captured. However, the burden on the eyes of each user can be reduced.

In the second embodiment of the present disclosure, as described above, the parallax is controlled only in the horizontal direction when a plurality of users viewing a three-dimensional stereoscopic video are present. Therefore, the burden on the eyes of each user can be reduced.

When the three-dimensional stereoscopic videos are displayed in accordance with the binocular parallax system, a region (reverse view region) in which right information and left information are reversed depending on a viewing angle may be present. Therefore, the burden is placed on the eyes of a user. Accordingly, the user detection unit 127 according to the above-described second embodiment may analyze an image captured by the image sensor 110 and detect whether the user is present at the reverse view region.

When the user is present at the reverse view region, the image generation unit 123 generates a two-dimensional image by performing control such that the parallax between right-eye and left-eye images is lost based on the detection result output from the user detection unit 127. Thus, when the user is present at the reverse view region, a two-dimensional image is generated and displayed by performing control such that the parallax is lost. Therefore, the burden on the eyes of the user can be reduced.

2-3. Third Embodiment

In the above-described first and second embodiments, an inclination of a user's face is detected based on an image captured by the image sensor 110, but the embodiments of the present disclosure are not limited thereto. For example, a relative inclination of a user's face may be detected using a sensor that is included in an information processing apparatus and detects an inclination of the information processing apparatus itself. The sensor that detects an inclination of the information processing apparatus itself may be, for example, an acceleration sensor or a geomagnetic sensor that detects an angle with respect to the gravity direction. In a third embodiment to be described below, a case in which an inclination of a user's face is detected using an acceleration sensor will be described.

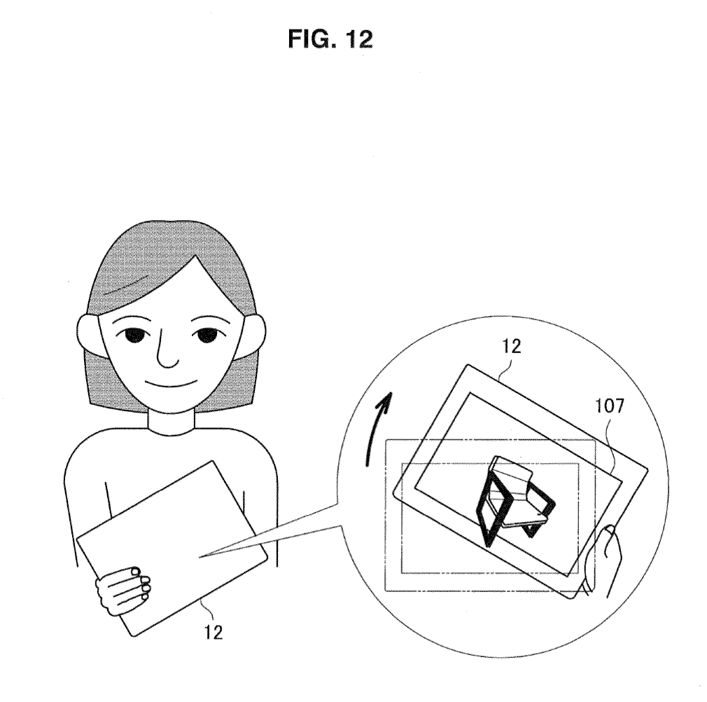

FIG. 12 is a diagram illustrating an information processing apparatus according to the third embodiment. When a user inclines an information processing device 12, as in FIG. 12, an opposing user's face (positions of two eyes) can be said to be inclined with respect to a display device 107 of the information processing apparatus 12. The information processing apparatus 12 according to this embodiment can reduce the burden on the eyes of a user by controlling parallax in the horizontal direction and/or parallax in the vertical direction in accordance with an inclination of a user's face inclined relatively with respect to the information processing apparatus 12, when the user inclines the information processing apparatus itself. Configuration of Information Processing Apparatus 12 According to Third Embodiment

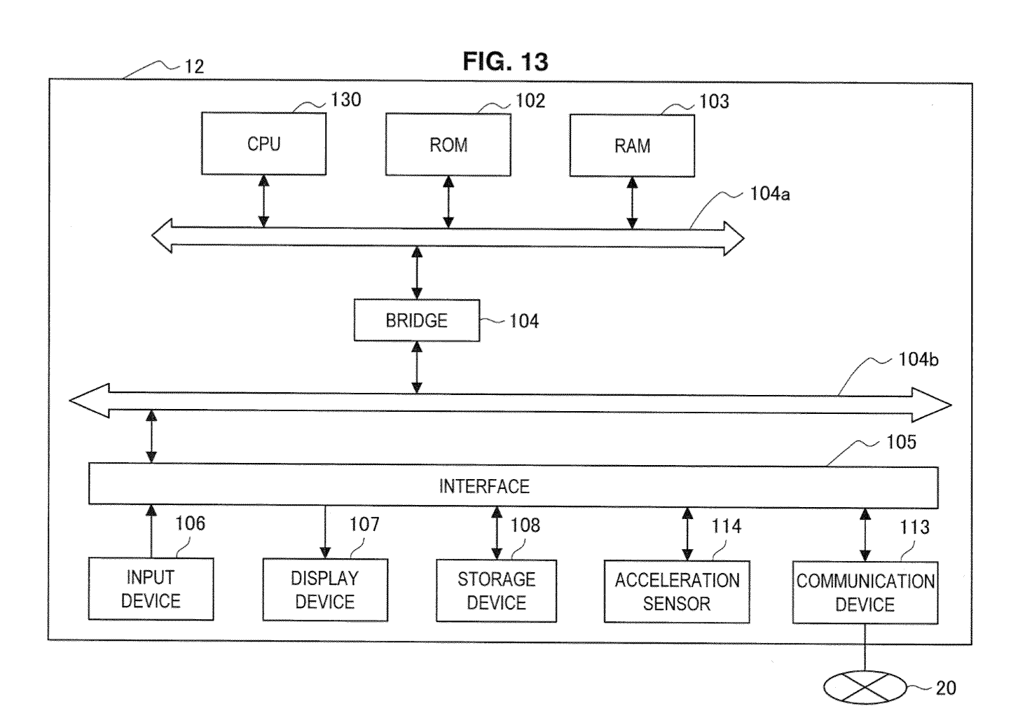

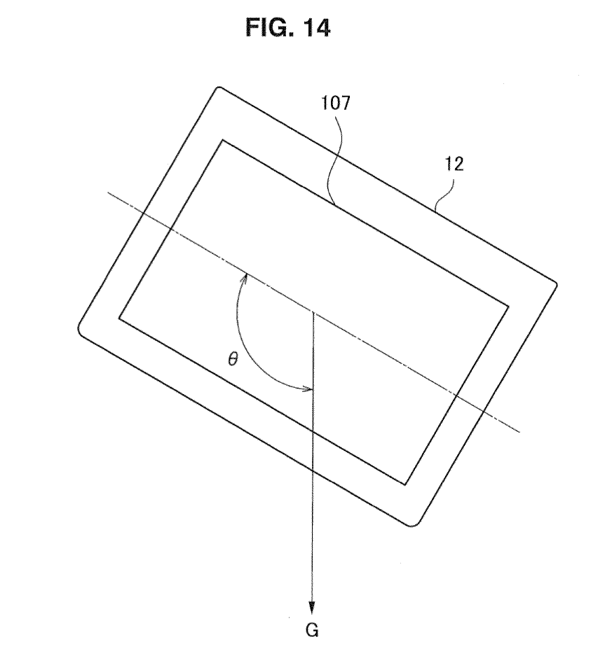

FIG. 13 is a block diagram illustrating the configuration of the information processing apparatus 12 according to the third embodiment of the present disclosure. As shown in FIG. 13, the information processing apparatus 12 according to the third embodiment is different from that of each embodiment described above in that the information processing apparatus 12 includes an acceleration sensor 114.

The acceleration sensor 114 can detect an inclination (angle) of the information processing apparatus itself with respect to the gravity direction by measuring an acceleration. Specifically, as shown in FIG. 14, the acceleration sensor 114 detects an inclination θ of the information processing apparatus itself (the information processing apparatus 12) with respect to a gravity direction G, and then outputs the detection result to the RAM 103.

Functional Configuration of CPU 130 According to Third Embodiment

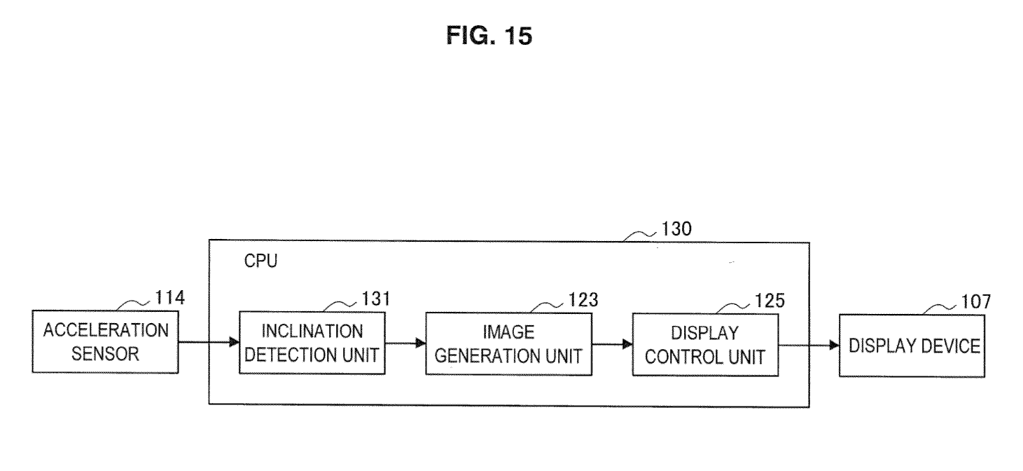

FIG. 15 is a diagram illustrating the functional configuration of the CPU 130 according to the third embodiment. As shown in FIG. 15, the inclination detection unit 131 of the CPU 130 detects an inclination of a user's face based on a detection result from the acceleration sensor 114.

In this embodiment, the acceleration sensor 114 outputs an inclination θ of the information processing apparatus itself (the information processing apparatus 12) with respect to the gravity direction G, as in FIG. 14. The inclination detection unit 131 detects an inclination θ of a user's face inclined relatively with respect to the information processing apparatus 12 based on the inclination θ of the information processing apparatus 12. Then, the inclination detection unit 131 outputs the detection result indicating the detected inclination θ of the user's face to the image generation unit 123.

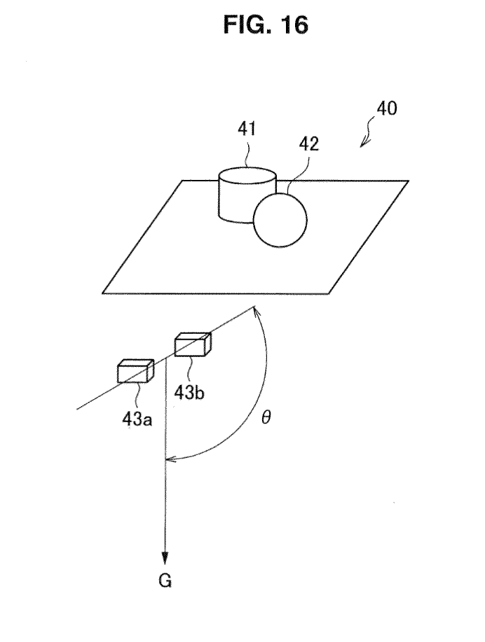

As shown in FIG. 16, the image generation unit 123 performs rendering by controlling the positions of virtual cameras 43a and 43b observing a virtual space 40 in accordance with the inclination θ of the user's face output from the inclination detection unit 131. Thus, the image generation unit 123 can generate right-eye and left-eye images having the parallax in the xy directions, as in each embodiment described above.

The image generation unit 123 outputs the generated right-eye and left-eye images to the display control unit 125. The display control unit 125 performs control such that the right-eye and left-eye images are displayed on the display device 107.

According to the third embodiment of the present disclosure, as described above, the information processing apparatus 12 includes the sensor that detects an inclination of the information processing apparatus itself and can detect a relative inclination of a user's face. Further, the information processing apparatus 12 can reduce the burden on the eyes of a user by controlling the parallax in the horizontal direction between three-dimensional stereoscopic videos or the parallax videos in the vertical direction between the three-dimensional stereoscopic videos in accordance with the inclination of the user's face, as in each embodiment described above.

3. Summarization

According to the embodiments of the present disclosure, as described above, the parallax in the horizontal direction between the three-dimensional stereoscopic videos and/or the parallax in the vertical direction between the three-dimensional stereoscopic videos can be controlled in accordance with the inclination of a user's face. Therefore, the burden on the eyes of the user can be reduced.

According to the embodiments of the present disclosure, the videos are allocated in not only the horizontal direction but also the vertical direction in the naked-eye-type system. Therefore, even when a user inclines his or her face, the user can view the three-dimensional stereoscopic videos.

According to the embodiments of the present disclosure, when a plurality of users simultaneously view the three-dimensional stereoscopic videos, the burden on the eyes of the users can be reduced by controlling only the parallax in the horizontal direction.

According to the embodiments of the present disclosure, when a user viewing the three-dimensional stereoscopic videos is present at the reverse view region, the burden on the eyes of the user can be reduced by performing the control such that the parallax is eliminated and the two-dimensional video is displayed.

According to the embodiments of the present disclosure, three-dimensional stereoscopic videos having the parallax in the horizontal and vertical directions (xy directions) can be generated by rotating the positions of the virtual cameras observing the virtual space in accordance with an inclination of a user's face.

It should be understood by those skilled in the art that various modifications, combinations, sub-combinations and alterations may occur depending on design requirements and other factors insofar as they are within the scope of the appended claims or the equivalents thereof.

Additionally, the present technology may also be configured as below.

(1) An information processing apparatus including:
an inclination detection unit that detects an inclination of a user's face in a horizontal direction of a display screen; and
a control unit that controls parallax in the horizontal direction between right-eye and left-eye images displayed on the display screen in accordance with a detection result of the inclination detection unit.

(2) The information processing apparatus according to (1), wherein the control unit controls parallax in a vertical direction between the right-eye and left-eye images displayed on the display screen in accordance with the detection result of the inclination detection unit.

(3) The information processing apparatus according to (1) or (2), wherein the control unit performs control such that the parallax is provided only in the horizontal direction between the right-eye and left-eye images when a plurality of users viewing the display screen are detected.

(4) The information processing apparatus according to any one of (1) to (3), wherein the control unit performs control such that the parallax between the right-eye and left-eye images is eliminated and a two-dimensional image is displayed when the user is present in a reverse view region.

(5) The information processing apparatus according to any one of (1) to (4), wherein the control unit acquires the right-eye and left-eye images having the parallax controlled in at least one of the horizontal and vertical directions by adjusting positions of a plurality of virtual cameras observing a virtual space created by modeling stereoscopic objects in accordance with the detection result of the inclination detection unit and performing rendering.

(6) The information processing apparatus according to any one of (1) to (5), further including: an imaging unit that images the user's face,
wherein the inclination detection unit detects the inclination of the user's face based on a user's face image captured by the imaging unit.

(7) The information processing apparatus according to any one of (1) to (6), further including:
a sensor that detects an inclination of the information processing apparatus itself,
wherein the inclination detection unit detects the inclination of the user's face based on the detection result of the sensor.

(8) The information processing apparatus according to any one of (1) to (7), wherein an optical element that allocates images displayed on the display screen in the horizontal and vertical directions is installed on a front surface of the display screen.

(9) The information processing apparatus according to (8), wherein the optical element is a parallax barrier in which parallax barriers blocking light and slits which are regions transmitting the light between the parallax barriers are arranged in a lattice shape.

(10) The information processing apparatus according to (8), wherein the optical element is a lens in which a plurality of lenticular lenses are arranged in a grid-like shape.

(11) A display control method including:
detecting an inclination of a user's face in a horizontal direction of a display screen; and
controlling parallax in the horizontal direction between right-eye and left-eye images displayed on the display screen in accordance with a detection result obtained by the step of detecting the inclination.

(12) A program causing a computer to execute:
a process of detecting an inclination of a user's face in a horizontal direction of a display screen; and
a process of controlling parallax in the horizontal direction between right-eye and left-eye images displayed on the display screen in accordance with a detection result obtained by the process of detecting the inclination.

(13) The program according to (12), wherein, in the controlling process, parallax in the horizontal direction between the right-eye and left-eye images displayed on the display screen is controlled in accordance with the detection result obtained by the process of detecting the inclination.

(14) The program according to (12) or (13), wherein, in the controlling process, the control is performed such that the parallax is provided only in the horizontal direction between the right-eye and left-eye images when a plurality of users viewing the display screen are detected.

(15) The program according to any one of (12) to (14), wherein, in the controlling process, the control is performed such that the parallax between the right-eye and left-eye images is eliminated and a two-dimensional image is displayed when the user is present in a reverse view region.

(16) The program according to any one of (12) to (15), wherein, in the controlling process, the right-eye and left-eye images having the parallax controlled in at least one of the horizontal and vertical directions are acquired by adjusting positions of a plurality of virtual cameras observing a virtual space created by modeling stereoscopic objects in accordance with the detection result obtained by the process of detecting the inclination and performing rendering.

(17) The program according to any one of (12) to (16), wherein, in the process of detecting the inclination, the inclination of the user's face is detected based on a user's face image captured by an imaging unit.

(18) The program according to any one of (12) to (17), wherein, in the process of detecting the inclination, the inclination of the user's face is detected based on the detection result of a sensor that detects an inclination of an information processing apparatus.

The present disclosure contains subject matter related to that disclosed in Japanese Priority Patent Application JP 2011-241234 filed in the Japan Patent Office on Nov. 2, 2011, the entire content of which is hereby incorporated by reference.

What is claimed is:

1. An information processing apparatus comprising:
an inclination detection unit that detects an inclination of a user's face in a horizontal direction of a display screen; and
a control unit that controls parallax in the horizontal direction between right-eye and left-eye images displayed on the display screen in accordance with a detection result of the inclination detection unit.

2. The information processing apparatus according to claim 1, wherein the control unit controls parallax in a vertical direction between the right-eye and left-eye images displayed on the display screen in accordance with the detection result of the inclination detection unit.

3. The information processing apparatus according to claim 2, wherein the control unit performs control such that the parallax is provided only in the horizontal direction between the right-eye and left-eye images when a plurality of users viewing the display screen are detected.

4. The information processing apparatus according to claim 2, wherein the control unit performs control such that the parallax between the right-eye and left-eye images is eliminated and a two-dimensional image is displayed when the user is present in a reverse view region.

5. The information processing apparatus according to claim 2, wherein the control unit acquires the right-eye and left-eye images having the parallax controlled in at least one of the horizontal and vertical directions by adjusting positions of a plurality of virtual cameras observing a virtual space created by modeling stereoscopic objects in accordance with the detection result of the inclination detection unit and performing rendering.

6. The information processing apparatus according to claim 2, further comprising:
an imaging unit that images the user's face,
wherein the inclination detection unit detects the inclination of the user's face based on a user's face image captured by the imaging unit.

7. The information processing apparatus according to claim 2, further comprising:
a sensor that detects an inclination of the information processing apparatus itself,
wherein the inclination detection unit detects the inclination of the user's face based on the detection result of the sensor.

8. The information processing apparatus according to claim 2, wherein an optical element that allocates images displayed on the display screen in the horizontal and vertical directions is installed on a front surface of the display screen.

9. The information processing apparatus according to claim 8, wherein the optical element is a parallax barrier in which parallax barriers blocking light and slits which are regions transmitting the light between the parallax barriers are arranged in a lattice shape.

10. The information processing apparatus according to claim 8, wherein the optical element is a lens in which a plurality of lenticular lenses are arranged in a grid-like shape.

11. A display control method comprising:
detecting an inclination of a user's face in a horizontal direction of a display screen; and
controlling parallax in the horizontal direction between right-eye and left-eye images displayed on the display screen in accordance with a detection result obtained by the step of detecting the inclination.

12. A program causing a computer to execute:
a process of detecting an inclination of a user's face in a horizontal direction of a display screen; and
a process of controlling parallax in the horizontal direction between right-eye and left-eye images displayed on the display screen in accordance with a detection result obtained by the process of detecting the inclination.

13. The program according to claim 12, wherein, in the controlling process, parallax in the horizontal direction between the right-eye and left-eye images displayed on the display screen is controlled in accordance with the detection result obtained by the process of detecting the inclination.

14. The program according to claim 13, wherein, in the controlling process, the control is performed such that the parallax is provided only in the horizontal direction between the right-eye and left-eye images when a plurality of users viewing the display screen are detected.

15. The program according to claim 13, wherein, in the controlling process, the control is performed such that the parallax between the right-eye and left-eye images is eliminated and a two-dimensional image is displayed when the user is present in a reverse view region.

16. The program according to claim 13, wherein, in the controlling process, the right-eye and left-eye images having the parallax controlled in at least one of the horizontal and vertical directions are acquired by adjusting positions of a plurality of virtual cameras observing a virtual space created by modeling stereoscopic objects in accordance with the detection result obtained by the process of detecting the inclination and performing rendering.

17. The program according to claim 13, wherein, in the process of detecting the inclination, the inclination of the user's face is detected based on a user's face image captured by an imaging unit.

18. The program according to claim 13, wherein, in the process of detecting the inclination, the inclination of the user's face is detected based on the detection result of a sensor that detects an inclination of an information processing apparatus.
